(19) United States
(12) Patent Application Publication
(10) Pub. No.: US 2008/0191633 A1
(43) Pub. Date: Aug. 14, 2008

(54) Serial light-emitting light structure

(76) Inventor: Chi-Shih Lai, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/705,017

(22) Filed: Feb. 12, 2007

(51) Int. Cl. H05B 41/00

(52) U.S. Cl. 315/185 S

(57) ABSTRACT

A serial light-emitting light structure is provided, which consists of a plurality of LED lights, an outer sleeve, a circuit panel, and an outer cover, wherein the plurality of LED lights is mounted onto the circuit panel, and the circuit panel is secured in the outer sleeve via an engagement mechanism between the outer sleeve and the outer cover, which ensures the integrity of the structure and realizes easier assembly, disassembly and replacement. In addition, the LED lights on the circuit panel can be enabled with various operation modes via the control circuit on the circuit panel.

### BACKGROUND OF THE INVENTION

1. Field of the Invention

The present invention is related to a light-emitting light structure, and particularly to a serial light-emitting light structure.

2. Description of the Related Art

A conventional Christmas string light employs an integrally formed decorative glasswork (outer cover) and a light base, wherein an inverted U-shaped circular base is formed on the inner engaging annular surface of the outer annular surface whose inside is bound to the decorative glasswork. The inner engaging annular surface provides an insertion for placing the Christmas lights which will thereby be prevented from being easily detached. Once the decorative glasswork is broken, the light base bound thereto together has to be removed. Otherwise, the appearance of the entire string light will be greatly affected if some of the lights are damaged.

Therefore, to improve the above problem, a serial light-emitting light structure has been provided according to the present invention, which has been applied with the general technology of an LED circuit of.

### SUMMARY OF THE INVENTION

A serial light-emitting light structure is provided according to the present invention, which mainly consists of a plurality of the LED lights, an outer sleeve, a circuit panel, and an outer cover, wherein the plurality of the LED lights are mounted onto the circuit panel, and the circuit panel is secured in the outer sleeve via an engaging mechanism between the round cap and the cover.

The serial light-emitting light structure is provided according to the present invention, comprising a circuit panel provided with a plurality of the LED lights; an outer sleeve, having a top surface with a wire gathering aperture thereon, and an opening designed with a slot for placing a circuit panel and a first engaging part; and an outer cover, having an annular opening designed with a second engaging part that can be engaged with the first engaging part. Furthermore, in the light-emitting light structure according to the present invention, the control circuit for light-emitting lights comprises a control chip, a red light module, a blue light module, a green light module, a power supply unit, a first switch, a second switch, and a variable resistor for controlling the operating time of the control circuit. The user can select the light modules to be operated by switching the first switch, and switch the modes of each LED light between each light module by the second switch.

### BRIEF DESCRIPTION OF THE DRAWINGS

FIG. 1 is a schematic view of the appearance of the serial light-emitting light structure of the present invention;

FIG. 2 is an exploded diagram of the serial light-emitting light structure of the present invention;

FIG. 3 is a sectional view of the serial light-emitting light structure of the present invention;

FIG. 4 is a block diagram of the control circuit of the serial light-emitting light structure of the present invention;

FIG. 5 is a schematic view of an LED light circuit of the control circuit of the serial light-emitting light structure of the present invention; and

FIG. 6 is a schematic view of the assembled serial light-emitting light structure of the present invention.

### DETAILED DESCRIPTION OF PREFERRED EMBODIMENTS

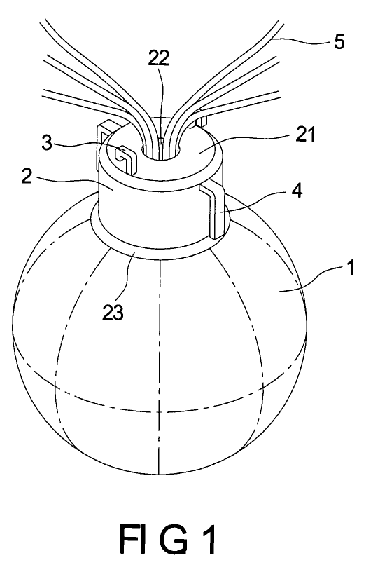

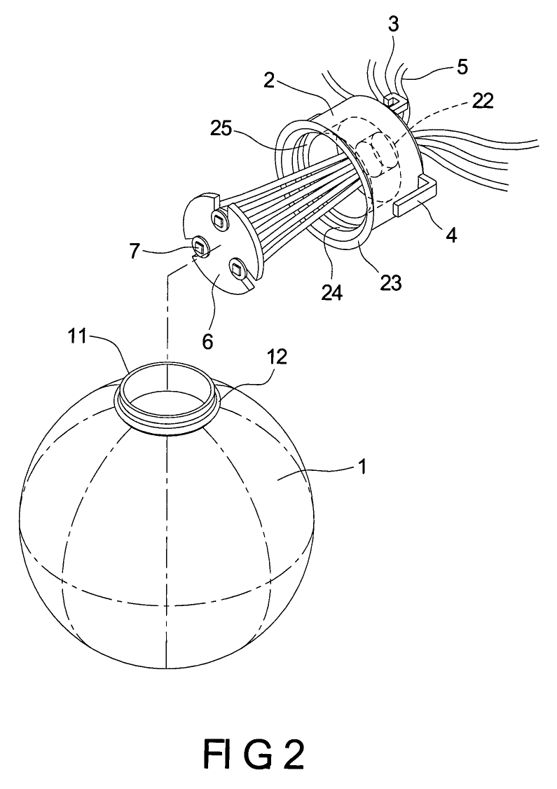

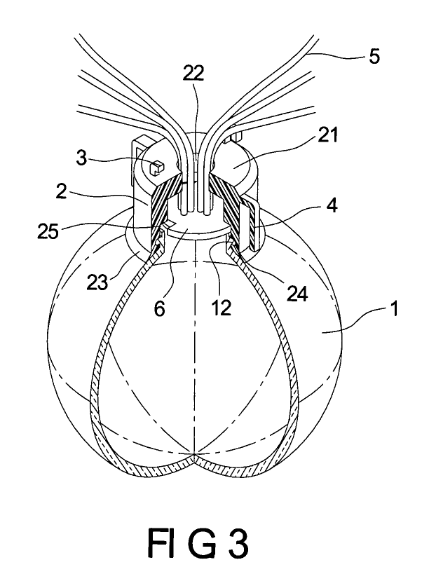

Referring to FIG. 1 to FIG. 3, parts of the serial light-emitting light according to the present invention and the assembly thereof are shown. FIG. 1 is a schematic view of the appearance of the serial light-emitting light structure of the present invention. FIG. 2 is an exploded diagram of the serial light-emitting light structure of the present invention. FIG. 3 is a sectional view of the serial light-emitting light structure of the present invention. The serial light-emitting light structure of the present invention comprises an outer cover 1, an outer sleeve 2, and a circuit panel 6.

The circuit panel 6 is mounted with a plurality of the LED lights 7 with a plurality of notches on the edge corresponding respectively to the LED lights 7. The activation flow of the LED lights 7 are regulated by the control circuit of the serial light-emitting light.

The outer sleeve 2 is a concaved cap, having a top surface 21 at the bottom with a wire gathering aperture 22 in the center, wherein the aperture 22 provides a common outlet for the wires of the LED lights 7 connected to the circuit panel 6. The outer sleeve 2 has a clip hook 4 provided on both sides of the peripheral annular surface, and a clasp hook 3 provided beside both sides of the wire gathering aperture 22 on the top surface 21. The clasp hooks 3 reversely correspond to each other, and the clip hooks 4 symmetrically correspond to each other. The outer sleeve 2 further has a slot 25 for placing the circuit panel 6 on the inside surface thereof. A first engaging part 24 is connected to the outer cover 1, wherein the first engaging part 24 is a groove. The slot 25 for placing the circuit in is separated from the top surface 21 at a distance so as to provide a space for gathering the wires for the LED lights 7 on the panel 6. In addition, the opening 23 of the outer sleeve 2 is designed with an arced surface.

The outer cover 1 has a round opening 11 with a second engaging part 12 thereon, which is a ridge. The second engaging part 12 is engaged with the first engaging part 24 of the outer sleeve 2, so that the outer cover 1 and the outer sleeve 2 are interlocked. Therefore the circuit panel 6 is prevented from being easily detached therefrom while the light emitted by the LED lights 7 can pass through the outer cover 1.

According to the present embodiment of the serial light-emitting light structure of the present invention, the outer sleeve 2, the wire gathering aperture 22, the circuit panel 6, outer cover 1, and the round opening 11 of the outer cover have been described as, but not limited to, being round. Various modifications and alterations, where the first engaging part 24 of the outer sleeve 2 is engaged with the second engaging part 12 of the outer cover 1, the outer sleeve 2 is disposed with the circuit panel 6 inside and the wires for LED lights 7 are gathered and outlet from the wire gathering aperture 22, should be included in the scope of the present invention. Therefore, the outer sleeve 2, the wire gathering aperture 22, the circuit panel 6, the outer cover 1, and the round opening 11 of the outer cover can be made into either planar or solid elements of a square, a triangle, or any other shape.

According to the present embodiment, the second engaging part 12 is an engaging ridge, and the first engaging part 24 is an engaging groove, which however, is by no means limiting of the present invention. Any equivalent means for engaging the ridge and the groove so that the opening 11 of the outer cover can be engaged to the outer sleeve 2 without undesired detachment shall fall into the scope of the present invention. Thus, the first engaging part 24 may be a ridge, while the second engaging part 12 may be a groove, or any other combination of an engagement mechanism.

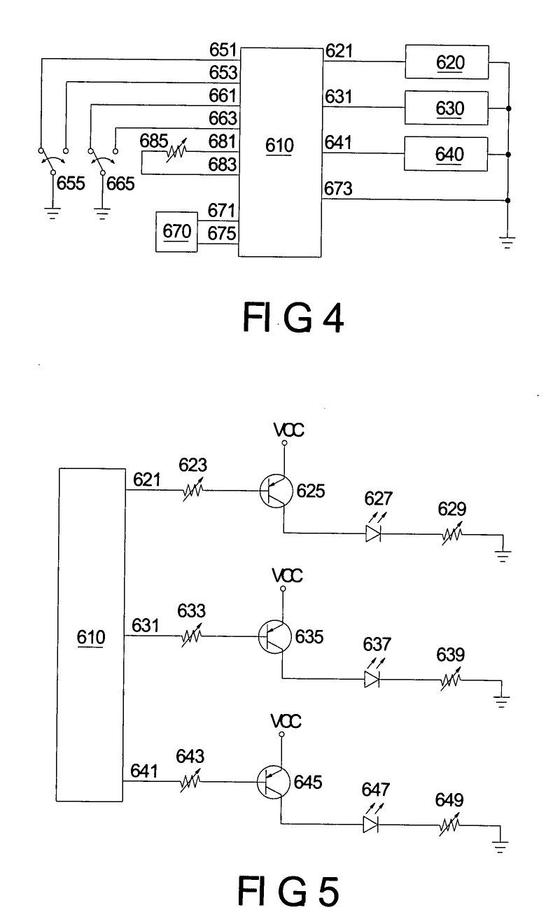

The serial light-emitting light of the present invention has light changes, and therefore, a control circuit for the serial light-emitting light is further provided herein, to explain the operation of the LED lights 7, as shown in FIG. 4, which is a block diagram of the control circuit for the serial light-emitting light of the present invention.

The control circuit for the serial light-emitting light comprises a control chip 610, a red light module 620, a blue light module 630, a green light module 640, a power supply unit 670, and a variable resistor 685 for controlling the operation time of the control circuit. The power supply unit 670 provides DC power via a pin 671 and AC power via a pin 675 to the control chip 610, and is further grounded via a pin 673, wherein the control chip 610 further controls the operation order and light emission of the red light module 620, the blue light module 630, and the green light module 640.

The control chip 610 controls the operation of the red, blue, and green light modules 620, 630 and 640 respectively through pins 621, 631 and 641. The red, blue, and green light modules 620, 630 and 640 all have the other end grounded.

The control chip 610 further provides pins 651 and 653 as control switch points, so that the user can alter the operating circuit of the LED lights 7 by the first switch 655, that is, the first swich 655 controls the LEDs 7 whether to operate, and the emitting lights of the LEDs 7 include two or three kinds of colors defined according to swiching the first switch 655. In other words, when the first switch is switched to the pin 651, the colors of two of the red light module 620, the blue light module 630 and the green light module 640 can be changed by the control chip 610, and that of the other one remains unchanged.

As above, pins 661 and 663 enable the control chip 610 to switch the operation mode of the LED lights 7, i.e., the mode of the LED lights 7, through the second switch 665. For example, if pin 661 controls the red, blue or green light module 620, 630, or 640 to flash alternatively, pin 663 controls the red, blue or green light module 620, 630, or 640 to lighten or dim gradually. As the second switch 665 is switched to the pin 661 so that the pin 661 is grounded, the red, blue or green light module 620, 630 or 640 generates alternatively and continuously flashing lights. As the second switch 665 is switched to the pin 663 so that the pin 663 is grounded, the red, blue or green light module 620, 630 or 640 generates gradually dimming or lightening changes as controlled by the control chip 610.

As the variable resistor 685 is connected to the pins 681 and 683, the operation time of the red, blue or green light module 620, 630 or 640 can be controlled through the control chip 610, by varying the resistance value of the variable resistor 685.

The control circuits in the red light module 620, the blue light module 630 and the green light module 640 are as shown in FIG. 5, which is a schematic view of the LED light circuit in the control circuit of the serial light-emitting light according to the present invention.

The red light module 620 comprises variable resistors 623 and 629, a control transistor 625 and a red LED light 627. The blue light module 630 comprises variable resistors 633 and 639, a control transistor 635, and a blue LED light 637. The green light module 640 comprises variable resistors 643 and 649, a control transistor 645, and a green LED light 647.

If the first switch 655 is switched to the pin 651 so that the pin 651 is grounded, the control chip 610 will control the operation of the red, blue and green light modules 620, 630 and 640. Thus, if the control transistor 625 is connected to a constant voltage power source VCC, the control chip 610 may send a signal to the control transistor 625 through the pin 621 to turn the transistor 625 on, and thereby to further turn on the red LED light 627. The switching direction of the first switch 655 can be predetermined.

Also, the control chip 610 may send a signal to the control transistor 635 through the pin 631 to turn the transistor 635 on, and thereby to further turn on the blue LED light 637; or send a signal to the control transistor 645 through the pin 641 to turn the transistor 645 on, and thereby to further turn on the green LED light 647.

While the operating time of each LED light can be regulated by the variable resistor 685, the operation changes of each LED light can be controlled by switching the second switch 665.

Though the LED light module of the present invention has employed an LED light, two variable resistors and a control transistor to achieve the operation and time order of the LED light module, it should not be deemed as limiting the present invention. Any combination of circuits, where the resistors, the transistors and the LED lights are assembled and the control chip 610 can be used to send a signal to turn the transistors ON and thereby the LED light ON, shall fall into the scope of the present invention. Thus, the variable resistors 623, 629, 633, 639, 643 and 649 can be replaced by fixed resistors, and the number of the red, blue and green LED lights 627, 637, and 647 and the elements corresponding to each LED light can be set or modified according to the requirements of the user.

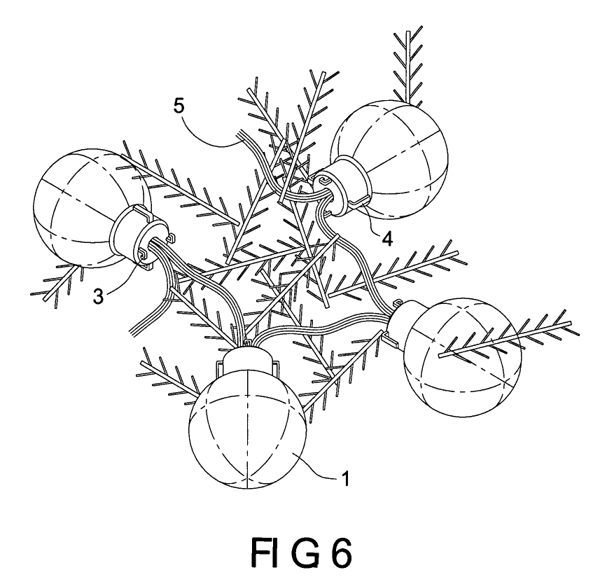

FIG. 6 is a schematic view of the assembled serial light emitting string light of the present invention. The assembled serial light emitting string light are serially connected using wires 5 connected to the LED lights 7, so that each light can be connected in serial as a long string, which can be used for Christmas decorations by creating a cheerful atmosphere with varied luminance of the lights. Furthermore, each light can be put up onto the tree by hanging the clip hooks 4 on the peripheral of the outer sleeve 2 onto small braches, which makes decorating much easier. Meanwhile, with the engaging mechanism of the present invention, the lights can be prevented from undesired detaching and are easy to assembly and disassembly.

The attached drawings are for reference only and by no means limiting of the scope of the present invention. The above embodiment is only a preferred embodiment of the present invention which should not be deemed as to limit the claims of the present invention. Any equivalent modification or alteration of the specification and drawings herein shall be included in the scope of the present invention, as defined by the claims.

What is claimed is:

1. A serial light-emitting light structure, comprising:
a circuit panel, with a plurality of the LED lights provided thereon, an outer sleeve, having a top surface and an opening, said top surface having a wire gathering aperture in the center, and said opening being designed with a slot for placing said circuit panel and a first engaging part, and
an outer cover, having a round opening, said round opening having a second engaging part to be engaged with the first engaging part, so as to attach the outer cover with the outer sleeve.

2. The serial light-emitting light structure according to claim 1, wherein said wire gathering aperture provides an outlet for the wires of the LED lights.

3. The serial light-emitting light structure according to claim 1, wherein said slot is separate from said top surface at a distance, so as to provide a space for gathering the wires of the LED lights.

4. The serial light-emitting light structure according to claim 1, wherein said first engaging part is an engaging groove and said second engaging part is an engaging ridge.

5. The serial light-emitting light structure according to claim 1, wherein said first engaging part is an engaging ridge and said second engaging part is an engaging groove.

6. The serial light-emitting light structure according to claim 1, wherein said circuit panel is designed with a plurality of notches.

7. The serial light-emitting light structure according to claim 6, wherein the number of notches corresponds to that of the LED lights.

8. The serial light-emitting light structure according to claim 1, wherein said outer sleeve further comprises multiple clip hooks which are provided on the peripheral annular surface of said outer sleeve.

9. The serial light-emitting light structure according to claim 1, wherein said outer sleeve further comprises multiple clasp hooks which are provided beside both sides of the wire gathering aperture on the top surface.

10. The serial light-emitting light structure according to claim 1, wherein said opening of said outer sleeve is designed with an arced surface.

11. The serial light-emitting light structure according to claim 1, wherein said circuit panel is placed in the slot of the outer sleeve, and is interlocked with said outer sleeve so as not to be detached therefrom by engaging said first engaging part of the outer sleeve to said second engaging part of the outer cover.

12. The serial light-emitting light structure according to claim 1, further comprising at least one control chip for controlling said LED lights.

13. The serial light-emitting light structure according to claim 12, further comprising a plurality of control transistors and a plurality of resistors, wherein said plurality of control transistors are turned ON by the control chip, so as to turn ON some of said LED lights.

14. The serial light-emitting light structure according to claim 12, further comprising a first switch and a second switch, wherein the first switch is used to determine the number of the LED lights to be ON, and the second switch is used to determine the operation modes of the LED lights.

15. The serial light-emitting light structure according to claim 12, further comprising a variable resistor, wherein the operation order of the LED lights is determined by the control chip according to the resistance value of the variable resistor.
